(19) United States
(12) Patent Application Publication
(10) Pub. No.: US 2019/0234854 A1
(43) Pub. Date: Aug. 1, 2019

(54) CLASSIFICATION PARTICLE SIZE DISTRIBUTION MODIFICATION TECHNIQUE BASED ON HYDROPHOBIC MEDIA FOR ENHANCED FLUIDIZED BED FLOTATION SEPARATION

(71) Applicant: CiDRA Corporate Services LLC, Wallingford, CT (US)

(72) Inventors: Alan D. KERSEY, South Glastonbury, CT (US); Paul J. ROTHMAN, Windsor, CT (US)

(21) Appl. No.: 16/339,216

(22) PCT Filed: Oct. 4, 2017
(86) PCT No.: PCT/US17/55048

§ 371 Date: Apr. 3, 2019

Related U.S. Application Data
(60) Provisional application No. 62/403,810, filed on Oct. 4, 2016.
(60) Provisional application No. 62/405,569, filed on Oct. 7, 2016.

(51) Int. Cl. G01N 15/02; B03C 5/02; B03D 1/02

(52) U.S. Cl. CPC G01N 15/0255; B03D 1/023; B03C 5/02

(57) ABSTRACT

Apparatus is provided for mineral separation, featuring a mixer configured to mix a mineral bearing ore feed and hydrophobic media particles, the mineral bearing ore feed being crushed and ground and having an ore particle size distribution characterized by about 50% or more of particles at a size of about 150 μm or less with finer particulates and mid-range particles, the hydrophobic polymer based particles having a media size of about 300 μm or more and being configured to collect the finer particulates and mid-range particles in the mineral bearing ore through hydrophobic attraction, and provide a modified feed having loaded “coarse particles” loaded with the finer particulates and mid-range particles attached thereto for further processing.

### CROSS-REFERENCE TO RELATED PATENT APPLICATIONS

This application also claims the benefit of U.S. Provisional Application No. 62/403,810 (712-2.432 (CCS-0164), filed 4 Oct. 2016, having a similar title, as well as U.S. Provisional Application No. 62/405,569 (712-2.439 (CCS-0175)), entitled “Three Dimensional Functionalized Open-Network Structure for Selective Separation of Mineral Particles in an Aqueous System”, filed 7 Oct. 2016, which are both incorporated by reference herein in their entirety.

### BACKGROUND OF THE INVENTION

### 1. Technical Field

This invention relates generally to techniques for separating valuable material from unwanted material in a mixture, such as a slurry; and more particularly, relates to a method and apparatus for separating valuable material from unwanted material in a mixture, such as a slurry, e.g., using an engineered collection media.

### 2. Description of Related Art

Froth flotation processing for the separation of materials is a widely utilized technology, particularly in the fields of minerals recovery, industrial waste water treatment, and paper recycling for example.

In the case of minerals separation, the mineral bearing ore is crushed and ground to a size, typically around 150 microns or less, such that a high degree of liberation occurs between the ore minerals and the gangue (waste) material. In the case of copper mineral extraction as an example, the ground ore is then suspended as slurry, or ‘pulp’, and mixed with reagents such as xanthates or other reagents, which render the copper sulfide particles hydrophobic.

Froth flotation is the process widely used for separating the valuable minerals from gangue. Flotation works by taking advantage of differences in the hydrophobicity of the mineral-bearing ore particles and the waste gangue. In this process, the pulp slurry of hydrophobic particles and hydrophilic particles is introduced to a water filled tank containing surfactant/frother which is aerated, creating bubbles. The hydrophobic particles attach to the air bubbles, which rise to the surface, forming a froth. The froth is removed and the concentrate is further refined.

In standard flotation separation air is constantly forced through the pulp slurry to create a certain ‘flux’ of air passing through the pulp. This process, while now used widely, and refined over many decades of use, has limitations:
In standard flotation cells, turbulence and the froth zone are detrimental to coarse particle flotation:
   Due to the natural dynamics of the bubbles, a mineral-bearing particle may not typically be carried to the surface on one bubble, but may have to attach, be detached and re-attach to several bubbles to reach the froth layer.
Larger particles containing minerals may not be lifted due to the limited buoyancy of a bubble, and the attractive forces between the bubble and the ore particle (created by the collector/hydrophobic chemical additives)

The above limitations due to particle buoyancy and bubble-particle detachment restrict their effectiveness when floating coarse particles. As a consequence, conventional flotation cells are effective for the recovery of fine particle size classes, typically finer than 150-200 micron. If the particle size that could be effectively recovered in a flotation cell could be increased, the product size from grinding could be significantly coarsened, resulting in a more eco-efficient flowsheet.

In general, 10% to 15% of the mineral bearing ore in the pulp is not recovered using air-based flotation processes, and consequently, new separation technologies are being explored and developed.

Other separation technologies developed for coarse particles include fluidized-bed based systems. Fluidized bed flotation systems such as the Eriez ‘HydroFloat’ system (See Awatey et al, “Optimization of operating parameters for coarse sphalerite flotation in the HydroFloat fluidized bed separator, Minerals Eng., 50-51, pp 99-105, (2013)) minimize these effects, as they reduce bubble-particle detachment in the pulp resulting from turbulence and the froth from bubble collapse. However, the recovery performance of a fluidized bed system is compromised if the feed contains too much fine material. A feed comprising a tighter distribution of particle size skewed to the coarser range allows recovery to be optimized.

The assignee of the present application has previously disclosed the use of polymer shells (aka “engineered bubbles/beads”) and polymer plates as a mineral separation method. See International patent application no. PCT/US2010/026744, filed 10 Mar. 2010, claiming benefit to provisional patent application No. 61/209,910, filed 11 Mar. 2009 (Docket no. 712-2.320-1//CCS-0025), as well as International patent application PCT/US2012/039,528, filed 25 May 2011, claiming benefit to provisional patent application No. 61/489,893, filed 25 May 2011 (Docket no. 712-2.356-1//CCS-0052), which are both incorporated by reference in their entirety. In this approach, a polymer material is modified to make the surface of the polymer attractive to the mineral of interest—either through hydrophobic attraction, or other chemical linkage to the collectors on the mineral particles. In this process, minerals attach to the polymer shells and separation is achieved via flotation of these ‘engineered bubbles’. This approach/system exhibits a higher degree of robustness than conventional air-bubble flotation. Alternatively, the polymer is used to form, or coat plates, or belts, in which case the mineral particles adhere to the surfaces, and on removal from a cell, the bound mineral can be washed off (with the release being chemically triggered—e.g., pH for example), or mechanically released (e.g., vibration/ultrasonically for example).

There is a need in the industry to provide a better way to separate valuable material from unwanted material, e.g., including in such a fluidized bed separator.

### SUMMARY OF THE INVENTION

### The Apparatus

According to some embodiments, the present invention may take the form of apparatus for mineral separation, featuring a mixer configured to
mix a mineral bearing ore feed and hydrophobic media particles, the mineral bearing ore feed being crushed and ground and having an ore particle size distribution characterized by about 50% or more of particles at a size of about 150 μm or less with finer particulate and mid-range particles, the hydrophobic polymer based particles having a media size of about 300 μm or more and being configured to collect the finer particulate and mid-range particles in the mineral bearing ore through hydrophobic attraction, and
provide a modified feed having loaded “coarse particles” with the finer particulate and mid-range particles attached thereto for further processing.

The apparatus may also include one or more of the following features:

The apparatus may include a fluidized bed separator configured to receive the modified feed, and provide a fluidized bed separator output having recovered coarse particles.

The hydrophobic media particles may include hydrophobic polymer based particles.

The hydrophobic media particles may be in a range of about 300-400 μm that acts a core/carrier with smaller mineral bearing ore particles attached thereto, including the finer particulate and mid-range particles.

The hydrophobic media particles may be solid hydrophobic polymer microspheres.

The hydrophobic media particles may include a size and density configured to emulate coarser particulate in the mineral bearing ore feed.

The hydrophobic media particles may be configured with a denser core material and an outer polymer layer.

The apparatus may include an ore media release and wash cycle configured to receive the fluidized bed separator output, and provide recovered hydrophobic media particles for recycling to the mixer and recovered ore for further processing.

The ore media release and wash cycle may be implemented using chemical processing or mechanical agitation.

According to some embodiments, the present invention may include, or take the form of, apparatus that may include a mechanical screen configured to receive the modified feed, and provide the effective “coarse particles” and natural coarse particles for further processing. The fluidized bed separator may be configured to receive the natural coarse particles, and provide the fluidized bed separator output having recovered coarse ore. The ore media release and wash cycle may be configured to receive the effective “coarse particles”, and provide recovered ore having the finer particulate and mid-range particles, and also provides recovered hydrophobic media particles for recycling to the mixer.

### Hydrophobic Media Particles

The hydrophobic media particles may take the form of engineered collection medium, e.g., that may include a coating configured with a hydrophobic chemical selected from a group consisting of polysiloxanates, poly(dimethylsiloxane) and fluoroalkylsilane to provide the molecules.

The hydrophobic media particles may be made from a material selected from polyurethane, polyester urethane, reinforced urethanes, PVC coated PV, silicone, polychloroprene, polyisocyanurate, polystyrene, polyolefin, polyvinylchloride, epoxy, latex, fluoropolymer, polypropylene, phenolic, EPDM, and nitrile.

The hydrophobic media particles may be modified with tackifiers, plasticizers, crosslinking agents, chain transfer agents, chain extenders, adhesion promoters, aryl or alky copolymers, fluorinated copolymers, hexamethyldisilazane, silica or hydrophobic silica.

The hydrophobic media particles may include a layer made of a material selected from acrylics, butyl rubber, ethylene vinyl acetate, natural rubber, nitriles; styrene block copolymers with ethylene, propylene, and isoprene; polyurethanes, and polyvinyl ethers.

The denser core material may be made of plastic, ceramic, carbon fiber or metal.

The hydrophobic media particles may include, or take the form of, three-dimensional open-cell structure may include pores ranging from 10-200 pores per inch.

The hydrophobic media particles may include, or take the form of, a reticulated foam block providing the three-dimensional open-cell structure.

The hydrophobic media particles may include different open cell foams having different specific surface areas that are blended to recover a specific size distribution of mineral particles in the slurry.

### Open Cell Foam and its Characteristics

The three-dimensional open-cell structure may take the form of open cell foam.

The open cell foam may be made from a material or materials selected from a group that includes polyester urethanes, reinforced urethanes, composites like PVC coated PU, non-urethanes, as well as metal, ceramic, and carbon fiber foams and hard, porous plastics, in order to enhance mechanical durability.

The open cell foam may be coated with polyvinylchloride, and then coated with a compliant, tacky polymer of low surface energy in order to enhance chemical durability.

The open cell foam may be primed with a high energy primer prior to application of a functionalized polymer coating to increase the adhesion of the functionalized polymer coating to the surface of the open cell foam.

The surface of the open cell foam may be chemically or mechanically abraded to provide “grip points” on the surface for retention of the functionalized polymer coating.

The surface of the open cell foam may be with a functionalized polymer coating that covalently bonds to the surface to enhance the adhesion between the functionalized polymer coating and the surface.

The surface of the open cell foam may be coated with a functionalized polymer coating in the form of a compliant, tacky polymer of low surface energy and a thickness selected for capturing certain mineral particles and collecting certain particle sizes, including where thin coatings are selected for collecting proportionally smaller particle size fractions and thick coatings are selected for collecting additional large particle size fractions.

The specific surface area may be configured with a specific number of pores per inch that is determined to target a specific size range of mineral particles in the slurry.

### The Method

According to some embodiments, the present invention may take the form of a method for mineral separation, featuring steps
mixing, with a mixer, a mineral bearing ore feed and hydrophobic media particles, the mineral bearing ore feed being crushed and ground and having an ore particle size distribution characterized by about 50% or more of particles at a size of about 150 μm or less with finer particulate and mid-range particles, the hydrophobic polymer based particles having a media size of about 300 μm or more and being configured to collect the finer particulate and mid-range particles in the mineral bearing ore through hydrophobic attraction, and
providing, with the mixer, a modified feed having loaded “coarse particles” with the finer particulate and mid-range particles attached thereto for further processing.

The method may also include one or more of the features set forth herein.

### BRIEF DESCRIPTION OF THE DRAWING

Referring now to the drawing, which is not necessarily drawn to scale, the foregoing and other features and advantages of the present invention will be more fully understood from the following detailed description of illustrative embodiments, taken in conjunction with the accompanying drawing in which like elements are numbered alike:

FIG. 1 is a graph of cumulative (%) v. particle size (μm) showing a typical classifier output particle distribution for froth flotation separation with d₅₀ of ˜150 μm.

FIG. 2 is an illustration of an attachment of fines to hydrophobic media particles to create “effective coarse particles,” according to some embodiments of the present invention.

FIG. 3 is graph of cumulative (%) v. particle size (μm) showing an “effective” particle distribution (of the desired mineral-bearing ore particles) after mixing with the media to agglomerate fines and mid-range particles onto the media “carrier”, according to some embodiments of the present invention.

FIG. 4 is a block diagram of steps involved for implementing some embodiments of the present invention, including a final stage washing and media recycling.

FIG. 5 is a block diagram of steps required for pre-separation of fines and middlings prior to coarse particle separation via finalized bed or other system designed for coarse particle recovery.

### DETAILED DESCRIPTION OF THE INVENTION

The present invention provides an additional concept based on the use of hydrophobic polymer based particles for enhancing the performance of fluidized beds for minerals separation, e.g., by a “size—upgrading” approach.

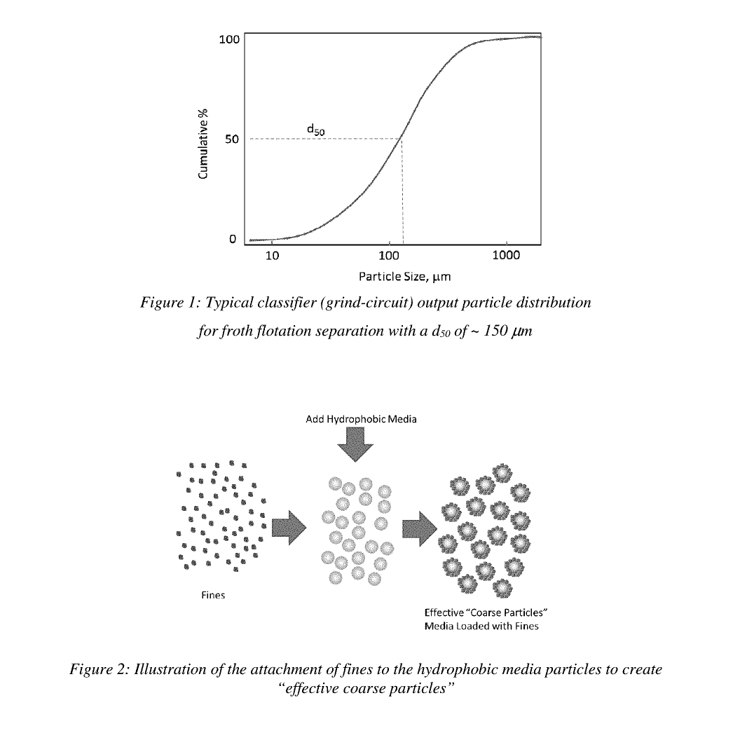

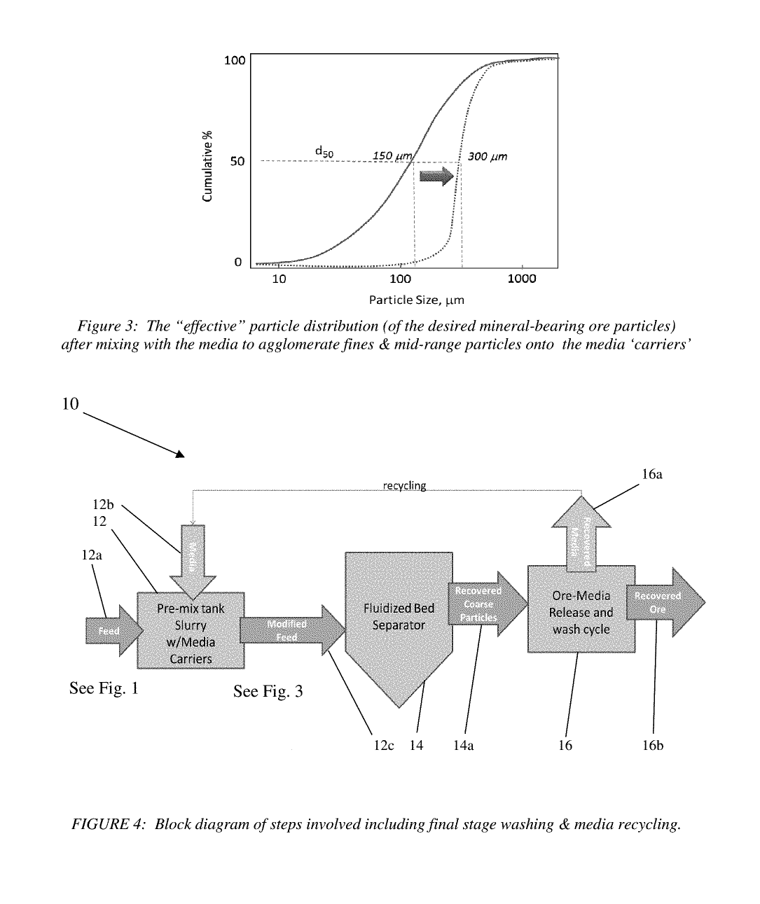

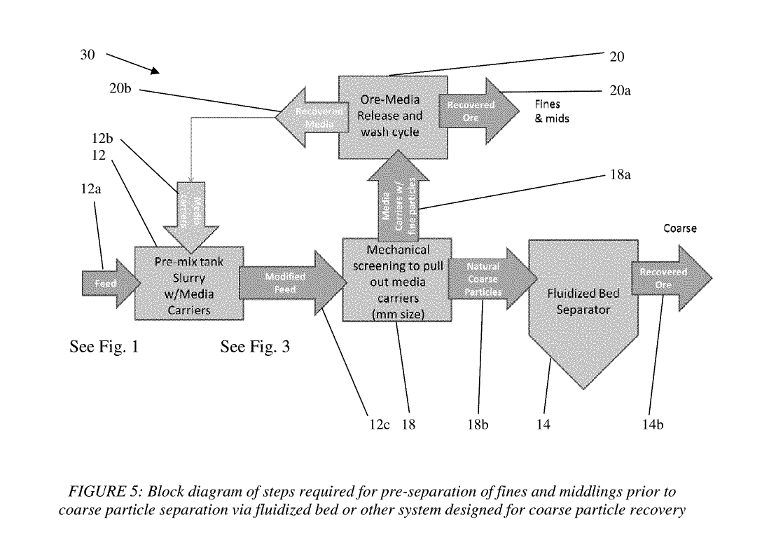

The output of a classifier (typical grind—hydrocyclone circuit) is an ore particle size distribution characterized by the form shown in FIG. 1. Here, more than 50% of the particles are at a size of about 150 μm or less.

In the present invention, solid hydrophobic polymer microspheres are added to the output of a classification system before mixture is added to a fluidized bed separator. These solid hydrophobic polymer microspheres, or other shaped particles, act as ‘carriers’ and preferentially collect up finer particulates through hydrophobic attraction. The added media would be of an appropriate size and density to emulate coarse particles (which could be accomplished by using a media carrier with a denser core material with an outer polymer layer); these then get recovered efficiently by the fluidized bed process as if they were coarse particles, but due to the agglomerating effect they have, pull fines & midrange particles to create effectively larger (clumped) particles, as illustrated in FIG. 2. The media size of the added media is chosen to be comparable to larger particles in the normal particle distribution—e.g., ˜300 to 400 μm; the media then acts as a core/carrier, with smaller mineral bearing ore particles attached.

Agglomeration of the fines to these particles, effectively ‘skews’ the particle distribution curve of the feed, moving more of the material from the fines to the larger particle category, as shown in FIG. 3. This ‘steepens’ the particle size distribution curve, creating a “narrower range” of particles for the fluidized bed system to work on, allowing optimization of the system/operating parameters of the fluidized bed system and overall recovery rates.

In summary, and by way of example, the media particles can be recovered via additional processing in a wash step, as illustrated in FIG. 4, and the media particles may be recycled for re-use in the process. This cleaning step can be achieved via a number of methods including chemical (solvent or pH), or mechanical agitation (including ultrasonic).

### FIG. 4

By way of example, FIG. 4 shows the present invention in the form of apparatus generally indicated as 10 having a mixer 12 configured to mix a mineral bearing ore feed 12a and hydrophobic media particles 12b, e.g., so as to form a pre-mix tank slurry with media carriers. The mineral bearing ore feed 12a may be received from an output of a classifier (not shown), e.g. which is crushed and ground and has an ore particle size distribution characterized by about 50% or more of particles at a size of about 150 μm or less with finer particulate and mid-range particles. The hydrophobic polymer based particles 12b have a media size of about 300 μm or more and are configured to collect the finer particulate and mid-range particles in the mineral bearing ore through hydrophobic attraction. After mixing the mineral bearing ore feed 12a and the hydrophobic media particles 12b, the mixer 12 provides a modified feed having effective “coarse particles” loaded with the finer particulate and mid-range particles for further processing. The effective “coarse particles” are also referred as to “loaded coarse particles.”

The apparatus 10 may also include a fluidized bed separator 14, e.g. configured to receive the modified feed 12c, further process the same, and provide a fluidized bed separator output 14a having recovered coarse particles.

The apparatus 10 may also include an ore media release and wash cycle 16, e.g., configured to receive the fluidized bed separator output 14a (e.g., the recovered coarse particles), and provide recovered hydrophobic media particles 16a for recycling to the mixer 12, as shown, and recovered ore 16b for further processing. By way of example, the ore media release and wash cycle 16 may be implemented using chemical processing or mechanical agitation.

### FIG. 5: Alternative Embodiments

In summary, the present invention may also be implemented by using a 2^{nd} “size—upgrading” concept, e.g., by adding media of appropriate size/density to the feed in a pre-mixing process that attract fines and middlings to emulate larger particles, which then get recovered using mechanical screening concepts. The natural coarse particles then go on to flotation recovery optimized for coarse recovery. By way of example, FIG. 5 illustrates this alternative embodiment. This is a form of a so-called “splitfeed recovery approach”.

In particular, FIG. 5 shows the present invention in the form of apparatus generally indicated as 30 that may include a mechanical screen 18 arranged between the mixer 12 and the fluidized bed separator 16. In operation, the mechanical screen 18 may be configured to receive the modified feed 12c, and provide the effective “coarse particles” or loaded coarse particles 18a and natural coarse particles 18b for further processing. The apparatus 30 may also include an ore media release and wash cycle 20, e.g., that may be configured to receive the effective “coarse particles” 18a, and provide recovered ore 20a having the finer particulate and mid-range particles, and also provides recovered hydrophobic media particles 20b for recycling back to the mixer 12. The fluidized bed separator 14 may be configured to receive the natural coarse particles 18b, and provide the fluidized bed separator output having recovered coarse ore.

Mixer 12, Separator 14, Screen 18, Ore-Media Release and Wash Cycle 16, 20

The mixer 12, the fluidized bed separator 14, the Ore-media release and wash cycle 16, 20 and screen 18 are known in the art, and the scope of the invention is not intended to be limited to any particular type or kind thereof either now know or later developed in the future.
Dow-Corning® 3-4222 Dielectric Firm Gel

By way of example, the hydrophobic media particles may include, or be coated in part, with hydrophobic silicone polymer including polysiloxane so that the collection surface becomes hydrophobic. In one embodiment of the present invention, the collection surface is made of polyurethane rubber coated with a silicone gel, such as Dow-Corning® 3-4222 Dielectric Firm Gel. The gel comes with two parts: Part A includes dimethyl siloxane, dimethylvinyl-terminated—68083-19-2; polydimethylsiloxane (PDMS)—63148-62-9; reaction of ethylene glycol and silica—170424-65-4; hydrotreated light naphthenic petroleum distillate—64742-53-6. Part B includes dimethyl siloxane, dimethylvinyl-terminated—68083-19-2; polydimethylsiloxane—63148-62-9; dimethyl siloxane, hydrogen-terminated—none; trimethylated silica—68909-20-6; dimethyl, methylhydrogen siloxane—68037-59-2.

### Applications

The scope of the invention is described in relation to mineral separation, including the separation of copper from ore. It should be understood that the synthetic beads according to the present invention, whether functionalized to have a collector or functionalized to be hydrophobic. Likewise, the functionalized filters and membranes, according to some embodiments of the present invention, are also configured for oilsands separation.

According to some embodiments of the present invention, the surface of a synthetic bead can be functionalized to have a collector molecule. The collector has a functional group with an ion capable of forming a chemical bond with a mineral particle. A mineral particle associated with one or more collector molecules is referred to as a wetted mineral particle. According to some embodiments of the present invention, the synthetic bead can be functionalized to be hydrophobic in order to collect one or more wetted mineral particles.

### The Related Family

This application is also related to a family of nine PCT applications, which were all concurrently filed on 25 May 2012, as follows:

PCT application no. PCT/US12/039528 (Atty docket no. 712-002.356-1), entitled “Flotation separation using lightweight synthetic bubbles and beads;”

PCT application no. PCT/US12/039524 (Atty docket no. 712-002.359-1), entitled “Mineral separation using functionalized polymer membranes;”

PCT application no. PCT/US12/039540 (Atty docket no. 712-002.359-2), entitled “Mineral separation using sized, weighted and magnetized beads;”

PCT application no. PCT/US12/039576 (Atty docket no. 712-002.382), entitled “Synthetic bubbles/beads functionalized with molecules for attracting or attaching to mineral particles of interest,” which corresponds to U.S. Pat. No. 9,352,335;

PCT application no. PCT/US/039596 (Atty docket no. 712-002.384), entitled “Synthetic bubbles and beads having hydrophobic surface;”

PCT application no. PCT/US/039631 (Atty docket no. 712-002.385), entitled “Mineral separation using functionalized filters and membranes, “which corresponds to U.S. Pat. No. 9,302,270;”

PCT application no. PCT/US12/039655 (Atty docket no. 712-002.386), entitled “Mineral recovery in tailings using functionalized polymers;” and

PCT application no. PCT/US12/039658 (Atty docket no. 712-002.387), entitled “Techniques for transporting synthetic beads or bubbles In a flotation cell or column,” all of which are incorporated by reference in their entirety.

This application also related to PCT application no. PCT/US2013/042202 (Atty docket no. 712-002.389-1/CCS-0086), filed 22 May 2013, entitled “Charged engineered polymer beads/bubbles functionalized with molecules for attracting and attaching to mineral particles of interest for flotation separation,” which claims the benefit of U.S. Provisional Patent Application No. 61/650,210, filed 22 May 2012, which is incorporated by reference herein in its entirety.

This application is also related to PCT/US2014/037823, filed 13 May 2014, entitled “Polymer surfaces having a siloxane functional group,” which claims benefit to U.S. Provisional Patent Application No. 61/822,679 (Atty docket no. 712-002.395/CCS-0123), filed 13 May 2013, as well as U.S. patent application Ser. No. 14/118,984 (Atty docket no. 712-002.385/CCS-0092), filed 27 Jan. 2014, and is a continuation-in-part to PCT application no. PCT/US12/039631 (712-2.385//CCS-0092), filed 25 May 2012, which are all hereby incorporated by reference in their entirety.

This application also related to PCT application no. PCT/US13/028303 (Atty docket no. 712-002.377-1/CCS-0081/82), filed 28 Feb. 2013, entitled “Method and system for flotation separation in a magnetically controllable and steerable foam,” which is also hereby incorporated by reference in its entirety.

This application also related to PCT application no. PCT/US16/057334 (Atty docket no. 712-002.424-1/CCS-0151), filed 17 Oct. 2016, entitled “Opportunities for recovery augmentation process as applied to molybdenum production,” which is also hereby incorporated by reference in its entirety.

This application also related to PCT application no. PCT/US16/037322 (Atty docket no. 712-002.425-1/CCS-0152), filed 17 Oct. 2016, entitled “Mineral beneficiation utilizing engineered materials for mineral separation and coarse particle recovery,” which is also hereby incorporated by reference in its entirety.

This application also related to PCT application no. PCT/US16/062242 (Atty docket no. 712-002.426-1/CCS-0154), filed 16 Nov. 2016, entitled “Utilizing engineered media for recovery of minerals in tailings stream at the end of a flotation separation process,” which is also hereby incorporated by reference in its entirety.

This application is related to PCT application serial no. PCT/US16US/068843 (Atty docket no. 712-002.427-1/CCS-0157), entitled “Tumbler cell form mineral recovery using engineered media,” filed 28 Dec. 2016, which claims benefit to Provisional Application No. 62/272,026, entitled “Tumbler Cell Design for Mineral Recovery Using Engineered Media”, filed 28 Dec. 2015, which are both incorporated by reference herein in their entirety.

### The Scope of the Invention

It should be further appreciated that any of the features, characteristics, alternatives or modifications described regarding a particular embodiment herein may also be applied, used, or incorporated with any other embodiment described herein. It should be noted that the engineered collection media having the open-cell structure, e.g., like that disclosed in U.S. Provisional Application No. 62/405,569, which can be made of a material that has a specific gravity smaller than, equal to or greater than that of the slurry. The engineered collection media can be made from a magnetic polymer or have a magnetic core so that the para-, ferri-, ferro-magnetism of the engineered collection media is greater than the para-, ferri-, ferro-magnetism of the unwanted ground ore particles in the slurry. Thus, although the invention has been described and illustrated with respect to exemplary embodiments thereof, the foregoing and various other additions and omissions may be made therein and thereto without departing from the spirit and scope of the present invention.

1-25. (canceled)

26. Apparatus for mineral separation, comprising:
a mixer configured to mix a mineral bearing ore feed and hydrophobic media particles, the mineral bearing ore feed being crushed and ground and having an ore particle size distribution characterized by about 50% or more of particles at a size of about 150 μm or less with finer particulates and mid-range particles, the hydrophobic media particles having a media size of about 300 μm or more and being configured to collect the finer particulates and mid-range particles in the mineral bearing ore through hydrophobic attraction, and
provide a modified feed having loaded coarse particles with the finer particulates and mid-range particles attached thereto for further processing.

27. Apparatus according to claim 26, wherein the apparatus comprises a fluidized bed separator configured to receive the modified feed, and provide a fluidized bed separator output having recovered coarse particles.

28. Apparatus according to claim 26, wherein the hydrophobic media particles are hydrophobic polymer based particles.

29. Apparatus according to claim 26, wherein the hydrophobic media particles are in a range of about 300-400 μm that acts a core/carrier with smaller mineral bearing ore particles attached thereto, including the finer particulates and mid-range particles.

30. Apparatus according to claim 26, wherein the hydrophobic media particles are solid hydrophobic polymer microspheres.

31. Apparatus according to claim 26, wherein the hydrophobic media particles have a size and density configured to emulate coarser particulates in the mineral bearing ore feed.

32. Apparatus according to claim 31, wherein the hydrophobic media particles are configured with a denser core material and an outer polymer layer.

33. Apparatus according to claim 26, wherein the apparatus comprises an ore media release and wash cycle configured to receive the fluidized bed separator output, and provide recovered hydrophobic media particles for recycling to the mixer and recovered ore for further processing.

34. Apparatus according to claim 33, wherein the ore media release and wash cycle is implemented using chemical processing or mechanical agitation.

35. Apparatus according to claim 26, wherein the apparatus comprises a mechanical screen configured to receive the modified feed, and provide the loaded coarse particles and natural coarse particles for further processing.

36. Apparatus according to claim 35, wherein the apparatus comprises a fluidized bed separator configured to receive the natural coarse particles, and provide a fluidized bed separator output having recovered coarse ore.

37. Apparatus according to claim 35, wherein the apparatus comprises an ore media release and wash cycle configured to receive the loaded coarse particles, and provide recovered ore having the finer particulates and mid-range particles, and also provides recovered hydrophobic media particles for recycling to the mixer.

38. A method for mineral separation, comprising:
mixing, with a mixer, a mineral bearing ore feed and hydrophobic media particles, the mineral bearing ore feed being crushed and ground and having an ore particle size distribution characterized by about 50% or more of particles at a size of about 150 μm or less with finer particulates and mid-range particles, the hydrophobic media particles having a media size of about 300 μm or more and being configured to collect the finer particulates and mid-range particles in the mineral bearing ore through hydrophobic attraction, and
providing, with the mixer, a modified feed having loaded coarse particles with the finer particulates and mid-range particles attached thereto for further processing.

39. A method according to claim 38, wherein the method further receiving with a fluidized bed separator the modified feed, and provide a fluidized bed separator output having recovered coarse particles.

40. A method according to claim 38, wherein the hydrophobic media particles are hydrophobic polymer based particles.

41. A method according to claim 38, wherein the hydrophobic media particles are in a range of about 300-400 μm that acts a core/carrier with smaller mineral bearing ore particles attached thereto, including the finer particulates and mid-range particles.

42. A method according to claim 38, wherein the hydrophobic media particles are solid hydrophobic polymer microspheres.

43. A method according to claim 38, wherein the hydrophobic media particles have a size and density configured to emulate coarser particulates in the mineral bearing ore feed.

44. A method according to claim 43, wherein the hydrophobic media particles are configured with a denser core material and an outer polymer layer.

45. A method according to claim 38, wherein the method comprises receiving, with an ore media release and wash cycle, the fluidized bed separator output, and providing recovered hydrophobic media particles for recycling to the mixer and recovered ore for further processing.

46. A method according to claim 45, wherein the method comprises implementing the ore media release and wash cycle using chemical processing or mechanical agitation.

47. A method according to claim 38, wherein the method comprises receiving with a mechanical screen the modified feed, and providing with the mechanical screen, loaded coarse particles and natural coarse particles for further processing.

48. A method according to claim 47, wherein the method comprises receiving with a fluidized bed separator the natural coarse particles, and providing with the fluidized bed separator a fluidized bed separator output having recovered coarse ore.

49. Apparatus according to claim 48, wherein the method comprises receiving with an ore media release and wash cycle the loaded coarse particles, providing recovered ore having the finer particulates and mid-range particles, and also providing recovered hydrophobic media particles for recycling to the mixer.
